(19) United States
(12) Patent Application Publication
(10) Pub. No.: US 2025/0362561 A1
(43) Pub. Date: Nov. 27, 2025

(54) OPTICAL LOGIC AND QUANTUM-LIMITED SIGNAL PROCESSING IN LARGE-SCALE OPTOELECTRONIC CIRCUITS

(71) Applicants: Massachusetts Institute of Technology, Cambridge, MA (US); NTT Research, Inc., Sunnyvale, CA (US)

(72) Inventors: Saumil Bandyopadhyay, Cambridge, MA (US); Ryan Hamerly, Cambridge, MA (US); Dirk Englund, Cambridge, MA (US)

(21) Appl. No.: 19/214,313

(22) Filed: May 21, 2025

Related U.S. Application Data
(60) Provisional application No. 63/650,578, filed on May 22, 2024.

(51) Int. Cl. G02F 3/00; G02F 7/00; G06N 3/067

(52) U.S. Cl. CPC G02F 3/00; G02F 7/00; G06N 3/0675

(57) ABSTRACT

A new architecture for a photoelectric logic gate is disclosed. This architecture is energy-efficient, realizes a strong optical nonlinearity, and can be directly realized in modern photonics foundries without process modifications, enabling immediate application to current-day photonic systems. The new architecture utilizes the integration of current onto the intrinsic capacitance of the optical modulator.

This application claims priority to U.S. Provisional Patent Application Ser. No. 63/650,578, filed May 22, 2024, the disclosure of which is incorporated by reference in its entirety.

### STATEMENT REGARDING GOVERNMENT SUPPORT

This invention was made with government support under OIA2134891 and OMA1936314 awarded by the National Science Foundation. The government has certain rights in the invention.

### BACKGROUND

The global demand for computer processing power continues to rise exponentially, necessitating continued R&D towards improved compute efficiency, as expressed as, for example, FLOPS/Watt. One promising approach leverages the rapid scaling in complexity of photonic integrated circuits, which has introduced new opportunities for signal processing, computing, and artificial intelligence in the optical domain. Optical signal processing, which leverages ultra-high bandwidths, low latencies, and long-distance, low-energy interconnects, unlocks new applications in computing and machine learning that are too energy-inefficient or slow for traditional digital electronic systems.

A key barrier for optical signal processing, however, is the difficulty of realizing nonlinear operations in optics. All-optical material nonlinearities are notoriously weak, requiring Watt-class pump powers or high-finesse optical cavities to realize in modern devices.

Recently, electro-optical nonlinearities have emerged as a promising alternative to realizing nonlinear operations in optics. In these devices, part of the optical input is converted to an electrical signal that is used to drive an optical modulator, as shown in FIGS. 1A-1B. In this figure, the photogenerated current which may be from a photodiode 1, is used to drive a modulator 2 off resonance, which can be used to produce either self-modulation (as shown in FIG. 1A) or modulation of another optical field (as shown in FIG. 1B). The electrical signal in some implementations is amplified with external circuitry 3 or a transimpedance amplifier.

This intermediate electrical conversion enables efficient nonlinearities for optical signals; however, current realizations must trade off the efficiency, speed, and power consumption of the device. “Receiverless” electro-optical nonlinearities have been demonstrated to be extremely efficient but are limited to ˜ns carrier recombination lifetimes in silicon photonics, as discussed in S. Bandyopadhyay et al., “Single-chip photonic deep neural network with forward-only training,” Nature Photonics 18 1335-43 (2024). Alternatively, the modulation voltage can be amplified with a passive impedance, which improves device response but limits speeds to the RC time constant, as discussed in K. Nozaki et al., “Femtofarad optoelectronic integration demonstrating energy-saving signal conversion and nonlinear functions,” Nature Photonics 13 454-59 (2019), or with high-power electronic amplifiers that add latency and excess power consumption, as discussed in F. Ashtiani et al., “An on-chip photonic deep neural network for image classification,” Nature 606 501-506 (2022). Moreover, all realizations to date have produced a modulation that is dependent on the instantaneous optical power of the control signal. This architecture makes the nonlinear modulation susceptible to analog errors introduced by component manufacturing error, fluctuations in optical power, and device losses. As a result, cascading these devices to produce more complex nonlinear computation in the optical domain is extremely challenging.

Therefore, it would be beneficial if there were a system and method of realizing photoelectric logic gates.

### SUMMARY

A new architecture for a photoelectric logic gate is disclosed. This architecture is energy-efficient, realizes a strong optical nonlinearity, and can be directly realized in modern photonics foundries without process modifications, enabling immediate application to current-day photonic systems. The new architecture utilizes the integration of current onto the intrinsic capacitance of the optical modulator.

According to one embodiment, a photoelectric gate is disclosed. The photoelectric gate comprises a first port in communication with a first photodiode to receive a control signal; and an optical modulator to modulate an input signal to form an output signal; wherein photogenerated current from the first photodiode is integrated onto an intrinsic capacitance of the optical modulator to control a state of the optical modulator.

In some embodiments, the control signal and the input signal are different wavelengths to allow the photoelectric gate to serve as a wavelength converter. In some embodiments, the first photodiode comprises a single photon avalanche diode (SPAD) such that a single photon incident on the first photodiode is detected at the output signal. In some embodiments, the intrinsic capacitance and a quality factor of the optical modulator are selected such that a single photon incident on the first photodiode is detected at the output signal. In some embodiments, the optical modulator is a Mach-Zehnder modulator, tunable directional coupler, microring, microdisk, pn-doped silicon modulator or photonic crystal modulator.

In some embodiments, a second port is in communication with a second photodiode to receive a bias or reset signal, wherein photogenerated current from the second photodiode is subtracted from the photogenerated current from the first photodiode prior to being integrated onto the intrinsic capacitance of the optical modulator.

In certain embodiments, the photoelectric gate serves as a comparator that compares the control signal to the bias or reset signal and wherein the output signal indicates a result on the comparison.

According to another embodiment, an optical inverter is disclosed. The optical inverter comprises the photoelectric gate described above. In certain embodiments, the optical modulator is optically biased such that when it charges up to a maximum voltage, the input signal is extinguished such that the output signal is not present. In certain embodiments, the bias or reset signal is set to a fixed bias optical power.

According to another embodiment, an optical AND gate is disclosed. The optical AND gate comprises the optical inverter described above, and a second optoelectronic gate, wherein the second optoelectronic gate comprises: a second optical modulator to modulate a second input signal to form a second output signal; a third port in communication with a third photodiode to receive a second control signal; a fourth port in communication with a fourth photodiode to receive the output signal from the optical inverter, wherein photogenerated current from the fourth photodiode is subtracted from the photogenerated current from the third photodiode and then integrated onto the intrinsic capacitance of the second optical modulator to control a state of the second optical modulator; wherein the input signal to the optical inverter and the second optoelectronic gate is a pump; and wherein the inputs to the first port of the optical inverter and the third port of the second optoelectronic gate comprise the inputs to the optical AND gate; and the output signal from the second optoelectronic gate comprises the output of the optical AND gate.

According to another embodiment, an optical NAND gate is disclosed. The optical NAND gate comprises the optical AND gate described above, wherein an output of the second optoelectronic gate serves as an input to a second optical inverter.

According to another embodiment, an optical memory is disclosed. The optical memory comprises a first port in communication with a first photodiode to receive a control signal; a second port in communication with a second photodiode to receive a bias or reset signal; an optical modulator, wherein photogenerated current from the second photodiode is subtracted from the photogenerated current from the first photodiode prior to being integrated onto intrinsic capacitance of the optical modulator to control a state of the optical modulator; and a switch disposed between the photodiodes and the optical modulator, to isolate the optical modulator from the photodiodes in a memory storage mode and enable passage of current in a memory writing mode. In certain embodiments, a capacitor is in parallel with the intrinsic capacitance of the optical modulator to retain the state of the optical modulator.

According to another embodiment, an optical neural network is disclosed. The optical neural network comprises a photoelectric gate, comprising: an optical modulator to modulate an input signal to form an output signal; a first port in communication with a first photodiode to receive one of two signals obtained by homodyne mixing of an activation and weight signal; and a second port in communication with a second photodiode to receive a second of the two signals obtained by the homodyne mixing of the activation and weight signal, wherein photogenerated current from the second photodiode is subtracted from the photogenerated current from the first photodiode prior to being integrated onto intrinsic capacitance of the optical modulator to control a state of the optical modulator. In certain embodiments, the optical modulator is operated in a linear regime. In certain embodiments, the optical modulator is operated in a non-linear regime to apply an activation function to the input signal.

According to another embodiment, a plurality of photoelectric gates are disclosed. Each of the photoelectric gates comprises an optical modulator to modulate an input signal to form an output signal; a first port in communication with a first photodiode to receive a control signal; and a second port in communication with a second photodiode to receive a reset signal, wherein photogenerated current from the second photodiode is subtracted from the photogenerated current from the first photodiode prior to being integrated onto capacitance of the optical modulator to control a state of the optical modulator; wherein the reset signal to the plurality of photoelectric gates is globally generated and distributed using a diffractive optical element or a waveguide splitting tree.

According to another embodiment, a photoelectric gate is disclosed. The photoelectric gate comprises an optical modulator to modulate an input signal to form an output signal; a first port in communication with a first photodiode to receive a control signal; and a second port in communication with a second photodiode to receive a reset signal, wherein photogenerated current from the second photodiode is subtracted from the photogenerated current from the first photodiode prior to being integrated onto capacitance of the optical modulator to control a state of the optical modulator; and a switch is series with a low electrical impedance, wherein closing of the switch discharges the capacitance through the low electrical impedance.

According to another embodiment, a photelectric gate is disclosed. The photoelectric gate comprises an optical modulator to modulate an input signal to form an output signal; a first port in communication with a first photodiode to receive a control signal; and a second port in communication with a second photodiode to receive a reset signal, wherein photogenerated current from the second photodiode is subtracted from the photogenerated current from the first photodiode prior to being integrated onto capacitance of the optical modulator to control a state of the optical modulator, and an optical tap in communication with the output signal, where part of the output signal is fed back to the first port or the second port. In certain embodiments, the first port is in communication with a control signal and the part of the output signal is fed back to the second port. In certain embodiments, the second port is in communication with a control signal and the part of the output signal is fed back to the first port.

According to another embodiment, an optical digital to analog converter (DAC) is disclosed. The DAC comprises a first stage, comprising: a plurality of photoelectric gates, wherein each photoelectric gate comprises: a first port in communication with a first photodiode to receive a control signal, indicative of a digital value; a second port in communication with a second photodiode to receive a bias signal; and an optical modulator to modulate an input signal to form an output signal; wherein photogenerated current from the second photodiode is subtracted from the photogenerated current from the first photodiode prior to being integrated onto an intrinsic capacitance of the optical modulator to control a state of the optical modulator, wherein the optical modulator affects one wavelength; wherein a plurality of pump wavelengths are incoherently combined into a single bus waveguide through a binary tree of 2×1 splitters and serve as the input signal to the first stage; and a final stage, comprising: a photoelectric gate comprising: a first port in communication with a first final stage photodiode to receive the output signal from the first stage; a second port in communication with a second final stage photodiode to receive the bias signal; and a final stage optical modulator to modulate a second input signal to form a second output signal; wherein photogenerated current from the second final stage photodiode is subtracted from the photogenerated current from the first final stage photodiode prior to being integrated onto the intrinsic capacitance of the final stage optical modulator to control a state of the final stage optical modulator, and wherein the second output signal represents an analog representation of the digital values.

According to another embodiment, a photoelectric gate is disclosed. The photoelectric gate comprises an optical modulator to modulate an input signal to form an output signal; a digital logic gate having an input, and an output in communication with the optical modulator; a first port in communication with a first photodiode to receive a control signal; and a second port in communication with a second photodiode to receive a reset signal, wherein photogenerated current from the second photodiode is subtracted from the photogenerated current from the first photodiode prior to being integrated onto an input capacitance at the input of the digital logic gate disposed between the photodiodes and the optical modulator. In certain embodiments, the digital logic gate comprises an inverter. In certain embodiments, the digital logic gate comprises a second input, and the photoelectric gate comprises: a third port in communication with a third photodiode to receive a second control signal; and a fourth port in communication with a fourth photodiode to receive a second reset signal, wherein photogenerated current from the fourth photodiode is subtracted from the photogenerated current from the third photodiode prior to being integrated onto an intrinsic capacitance at the second input of the digital logic gate. In certain embodiments, the digital logic gate comprises an AND gate, a NAND gate, an OR gate or a NOR gate.

According to another embodiment, a surface is disclosed. The surface comprises a plurality of micromirrors; and a plurality of photoconductive switches, each associated with one of the plurality of micromirrors; wherein light incident on a photoconductive switch is converted to charge, which is integrated onto the capacitance of a respective micromirror to control the position of the micromirror.

### BRIEF DESCRIPTION OF THE DRAWINGS

For a better understanding of the present disclosure, reference is made to the accompanying drawings, in which like elements are referenced with like numerals, and in which:

FIGS. 1A-1B show that an electro-optical nonlinearity realizes nonlinear modulation of an optical signal by either itself or another optical signal by converting it to the electrical domain through a photodetector.

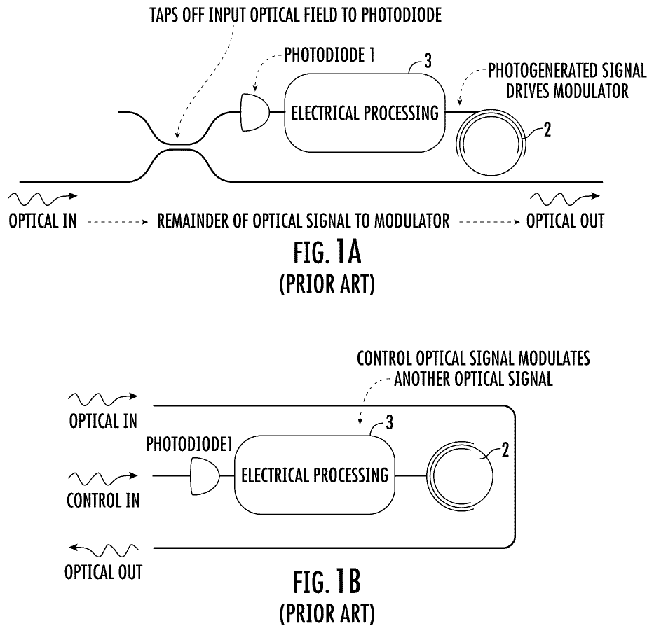

FIG. 2 shown the architecture of a photoelectric logic gate according to one embodiment.

FIG. 3 shows the simulated DC transmission of the photoelectric logic gate when the passive state of the modulator (no incident optical power) is on resonance.

FIGS. 4A-4C show a time-domain simulation of the implementation from FIG. 2.

FIG. 5 shows photoconductive switches coupled to micromirrors implementing a photoelectric gate for interfacing to free-space optical signals according to two embodiments. In this embodiment, charge is accumulated on a MEMS device that deflects a mirror out of plane for spatial light modulation.

FIG. 6 shows the coupling of an external capacitor to a modulator with negligible leakage which implements an “optical” memory. In this embodiment, the memory is programmed by inputting light into the photodiode. Once charge is injected into the capacitor, the switch is disconnected to eliminate leakage through the series resistance of the photodiode. The memory is read out by interrogating the modulator with an optical probe signal.

FIGS. 7A-7B shows different implementations that may be used to reset the device.

FIG. 8 shows the use of the device as an optical “accumulator” in a time-multiplexed optical neural network.

FIG. 9 shows the architecture of a four-bit optical DAC. The first stage weights pump wavelengths λ₀, λ₁, λ₂, λ₃ successively by factors of two and combines them into a single bus waveguide. Each wavelength is modulated by a receiverless electro-optical nonlinearity (including a balanced photoreceiver coupled to a microring modulator, as shown in inset). The modulated wavelengths are summed with a single photodetector, which drives a final modulator to produce the analog output.

FIGS. 10A-10B shows the implementation of an optical NOT gate and AND gate, respectively, using the photoelectric logic gate. Each modulator is passively biased to be off-resonant, except for the second modulator in the AND gate. Cascading these two gates enables implementation of an optical NAND gate, which is sufficient to realize universal logic.

FIG. 11 shows an alternate implementation of photoelectric logic gate that employs internal feedback. Here the output signal is tapped off (for example, with an integrated directional coupler) and fed back into one of the two gate inputs.

FIGS. 12A-12B show the photoelectric gate directly interfaced to digital electronic circuits.

FIGS. 13A-13B show the photoelectric gate used as a highly sensitive photodetector, potentially up to the single photon level.

### DETAILED DESCRIPTION

The disclosure is directed toward various large scale optoelectronic circuits. A new architecture for a photoelectric logic gate is disclosed. This architecture is energy-efficient, realizes a strong optical nonlinearity, and can be directly realized in modern photonics foundries without process modifications, enabling immediate application to current-day photonic systems. The architecture outperforms prior realizations of electro-optical nonlinearities in the following ways:

1. It is both fast and energy efficient. Prior electro-optical nonlinearities can be classified into one of two performance regimes:
1) power-hungry, fast (>20 GHz) electro-optical nonlinearities that make use of external transimpedance amplifiers to produce sufficient modulation voltages at high speeds; or
2) energy-efficient, slow (˜1 GHz) devices that use passive impedances to boost the modulation voltage. As these devices require impedances on the order of ˜100 kOhm and have capacitances on the order of ˜1 fF, they have been RC-limited to speeds of ˜1 GHz.

In contrast, this architecture can realize modulation with bandwidths exceeding 20 GHz, limited by the photodiode/modulator bandwidth, and does not require external amplifiers. As a result, this architecture can realize energy consumptions on the order of ˜1 fJ/OP.

2. Its response depends not on instantaneous optical power, but the integrated optical signal. This feature has immediate applications for emerging photonic accelerators for deep neural networks, as well as other systems that require inline processing of data in the optical domain.

3. It exhibits a bistability reminiscent of electrical logic gates, greatly reducing the effect of analog errors (as it is not dependent on instantaneous optical power, which is susceptible to power fluctuations) and enabling cascadability. This feature enables optical analogues to many key electronic components, including optical digital-to-analog converters (DACs) and digital optical logic.

4. Bistability enables implementation of key logic gates used in electronics. In particular, unlike prior realizations, this architecture can implement a NAND gate in the optical domain, which is sufficient to implement universal logic entirely in the optical domain.

Implementations of this device is presented and applications spanning machine learning, signal processing, and telecommunications are introduced.

### Integrated Photonic Implementation

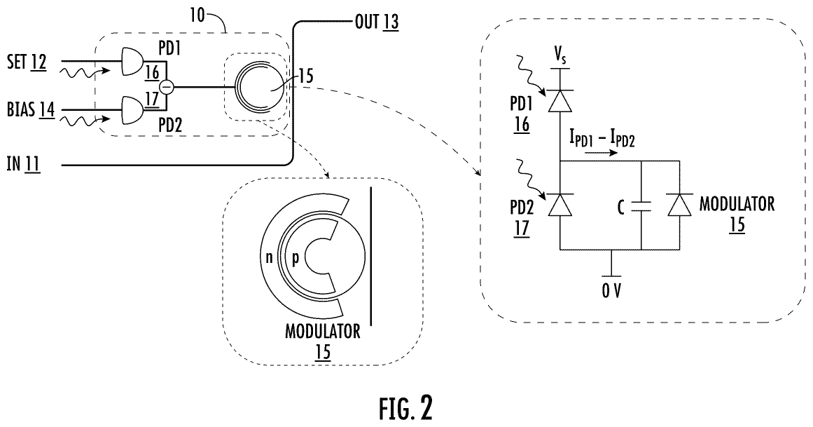

FIG. 2 shows one possible implementation of the photoelectric logic gate that utilizes standard photonic components. This device 10 functions as a three-terminal or four-terminal device that operates similarly to an electronic transistor. The optical signal is input into a modulator 15, which could take the form of a Mach-Zehnder modulator, tunable directional coupler, microring, microdisk, or photonic crystal modulator. As an example, this modulator 15 may be implemented in silicon photonics, where the device is pn-doped for fast modulation (see inset). Such a modulator device, which functions electrically as a diode, can be operated in forward bias, where charge is directly injected into the junction to produce efficient modulation, or reverse bias, where charges are depleted out of the junction to introduce a refractive index shift in the waveguide.

A “control” optical signal, analogous to the gate voltage for a field effect transistor, is input into the “SET” port 12, where it drives an optical photodiode 16. The optical photodiode 16, which converts input light to charge, drives the modulator 15 in a “receiverless” fashion without intermediate amplifier circuitry. The optical photodiode 16 has its cathode connected to the supply voltage and its anode connected to the modulator 15. In FIG. 2, this modulator 15 is assumed to be pn-doped and implemented in silicon photonics, but in other embodiments, it may be an electro-optic Pockels modulator, for instance implemented in lithium niobate, or an electro-absorption modulator, for instance implemented in indium phosphide.

As no current can pass through the modulator 15, the generated charge will flow into the intrinsic and parasitic capacitances within the circuit. If the electrical trace connecting the photodiode 16 is long (more than tens of microns), this current will charge the parasitic capacitance of the trace and be functionally useless.

However, if the modulator 15 and photodiode 16 are closely integrated on-chip, such that the modulator intrinsic capacitance (tens of femtofarads) dominates the capacitance of the circuit (i.e. the intrinsic capacitance is at least 10 times larger than the capacitance of the trace), the charge Q will be directly injected into the modulator intrinsic capacitance. This produces a voltage V=Q/C across the modulator 15, which can be exceptionally high with low levels of light, as C is on the order of ˜10 fF. For instance, ˜60,000 photons are sufficient to produce 1 V on the capacitor, which is about 7 fJ of optical energy.

In other words, the photogenerated current from the “control” optical signal input into the “SET” port 12 is directly integrated onto the intrinsic capacitance of an optical modulator 15. For a pn-doped modulator, the intrinsic capacitance may comprise the parasitic or junction capacitance. For an electro-optic Pockels modulator, the intrinsic capacitance may be the electrode capacitance. A separate “supply” optical signal, coupled into the “IN” port 11 and read out from the “OUT” port 13, is used to read out from the modulator 15. The parasitic capacitances of the trace and photodiode are not shown, but close integration of the devices can ensure the modulator capacitance is the dominant capacitance charge is injected into. A “BIAS” port 14 can be integrated into the gate to enable discharge of the modulator capacitance. The optical photodiode 17 has its cathode connected to the modulator 15 and its anode connected to ground. Here, the total charge injected depends on the difference current between the “SET” photodiode 16 and “BIAS” photodiode 17. Note that the “BIAS” Port 14 may also be used to reset the device 10, if it is maintained at a higher power optical signal than the “SET” port 12. The right side of FIG. 2 shows an electrical circuit representation of this device 10 when implemented with a pn-doped modulator in silicon photonics and shows the modulator 15 modelled as a diode and the intrinsic capacitor in parallel.

The upshot of this is that the transmission of the optical signal (which enters through the “IN” port 11 and exits through the “OUT” port 13) through the modulator 15 is determined by the “control” optical signal, much as current through a transistor is determined by a control gate voltage. In effect, an optical-to-optical nonlinear switch has been created.

Similar “optical” receiverless nonlinearities have been conceptualized before. This device 10, however, has a key architectural difference that enables it to outperform prior implementations. The response of this device 10 is not dependent on the instantaneous control signal, but the integrated signal. For a pn-doped modulator, the device is configured such that no current can be injected into the junction, as the diode remains under reverse bias. As the impedance of the modulator 15 is purely capacitive, i.e. there is no passive resistive load for the generated photocurrent to discharge through, the charge is directly integrated onto the modulator 15.

This integration is important. Integration enables many advantages:

1. Nonlinearities that are much stronger than existing devices can be achieved. Current implementations, which depend on the instantaneous optical power, require strong incident optical powers for a strong nonlinear response. This implementation, however, will integrate any optical power incident on the photodiode and will continue to do so until the supply voltage Vs is reached across the capacitance. The supply voltage Vs needs to be low enough to avoid inducing breakdown in the devices, but otherwise is not limited. For example, state-of-the-art microdisk modulators have an on-off voltage of about 1 V but can be biased to several volts before inducing breakdown. Thus, the photoelectric logic gate can realize multiple linewidths of detuning.

2. Consider a cascaded chain of these devices-suppose this device 10 drives an identical copy of it. If its response depended on the instantaneous power, then any fluctuation in the input signal would propagate through the chain and introduce an error in the output. It is this behavior that has precluded realization of “optical transistors”-analog errors cascade and accumulate!

Here, however, the modulator 15 can only charge up to the supply voltage. Thus, as long as an optical pulse is sufficient to charge up to the supply voltage, minute fluctuations in the incident optical signal will not introduce errors in the output.

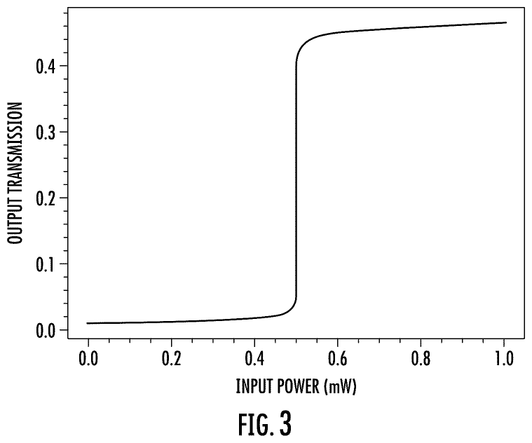

Note that it is not a single photodiode that drives the modulator, but the difference current of a balanced photoreceiver. Here, one photodiode acts as the input, or “SET” port 12, while the other acts as the threshold, or “BIAS” port 14. If the input optical signal is stronger than the “BIAS”, there is a net influx of charge onto the capacitor and the modulator detunes. On the other hand, if the input signal is weaker than “BIAS,” then net charge is depleted from the device and no voltage is applied to the modulator 15. The “BIAS” port 14 enables the threshold optical power to be freely programmed depending on the system. As an example, in FIG. 3, the simulated DC transmission of this device 10 is shown when 0.5 mW of optical power is incident on the “BIAS” port 14. When input power exceeds the BIAS power (here 0.5 mW), a strong bistability is produced in the output transmission.

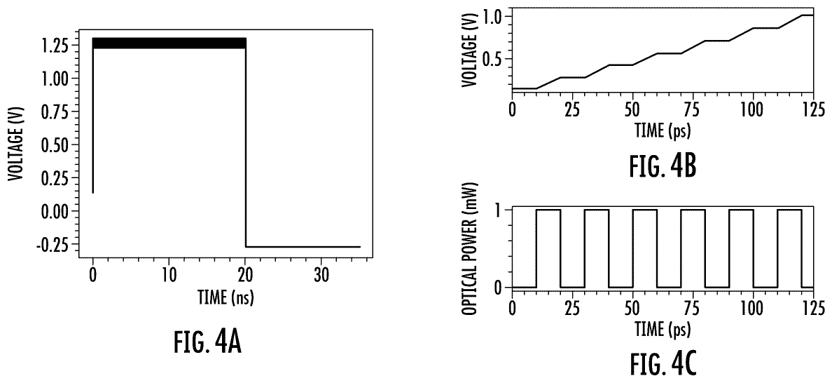

the FIGS. 4A-4C show a time-domain simulation of implementation from FIG. 2. The control signal applied to the “SET” port 12 is assumed to be an optical pulse sequence of 1000 pulses, each 10 ps duration, with 10 fJ of optical energy per pulse. At t=10 ns, the same pulse sequence applied to the “BIAS” port 14 discharges the capacitance. The supply voltage Vs is assumed to be 1 V, the photodiode capacitance is 15 fF, the parasitic trace capacitance is 2 fF, and the modulator intrinsic capacitance is 60 fF. FIG. 4A shows that the modulator 15 charges up to the top rail and then discharges to the ground rail when the same pulse sequence is applied to the “BIAS” port 14. The top rail is the supply voltage (1 V) plus the forward voltage of the photodiode 16 (assumed to be 0.3 V for a germanium photodiode, but could vary for other types of diodes), and the bottom rail is ground minus the photodiode forward voltage (−0.3 V). FIG. 4B shows that each pulse injects a fixed amount of charge onto the modulator capacitance causing it to increase and decrease in a step wise fashion, corresponding to a fixed voltage swing on the modulator. FIG. 4C shows the optical pulse sequence applied to the device in simulation.

Note that: a) the voltage does not increase beyond the top rail (the supply voltage (1 V) plus the forward voltage of the photodiode); and b) the voltage across the modulator 15 increases and decreases in a stepwise fashion, corresponding to the optical energy per pulse.

### Micromirror Implementation for Free-Space Optical Logic

The concept presented herein of integrating charge onto an intrinsic modulator capacitance is not limited to silicon photonic devices or carrier-based modulation schemes, but may also be applied to other platforms, such as silicon nitride and lithium niobate, and other phase shifter technologies, including MEMS, electro-optic modulators, and piezomechanical phase shifters.

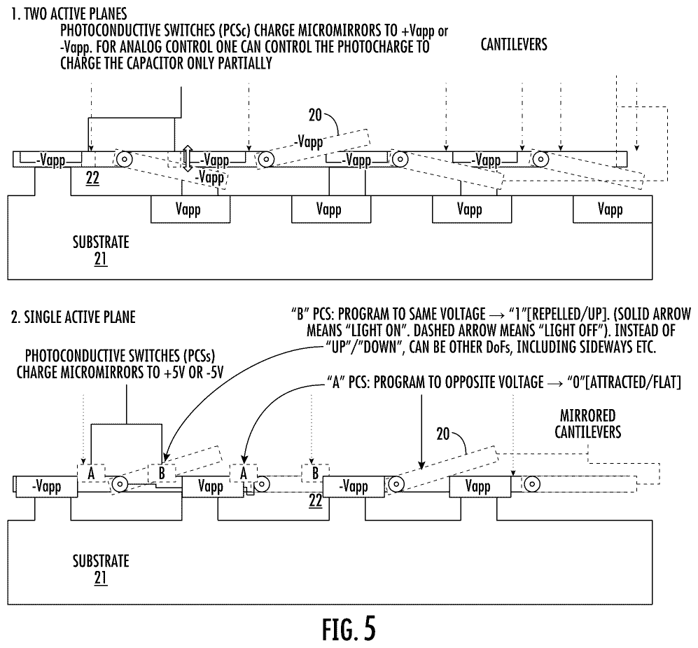

An alternative implementation is shown in FIG. 5 for interfacing with free-space input/output optical signals. Here, micromirrors 20 are mechanically deflected out of plane from a substrate 21 to realize spatial light modulation of free-space signals. Photoconductive switches 22 take input optical light, convert the signal to charge, and integrate it onto the capacitance of the micromirror 20, deflecting it out of plane. The mechanical deflection programs the spatial light modulator, which acts on the input optical signal. In one embodiment, shown at the top of FIG. 5, the micromirrors 20 are cantilevers and are capable of rotating in two different directions such that they can move both upward and downward relative to the horizontal plane. In this embodiment, the photoconductive switches 22 can charge the micromirrors 20 to −Vapp or +Vapp. For analog control, one can control the photocharge to charge the capacitor only partially. In another embodiment, shown at the bottom of FIG. 5, the micromirrors 20 are either in plane (horizontal), or rotated upward from the plane. Certain photoconductive switches 22 may charge to −Vapp, while others charge to +Vapp, where one rail causes the micromirror 20 to move upward and the other rail causes the micromirror 20 to be flat. In both cases, photoconductive switches 22 collect incident light and collect charge which is integrated onto the capacitance of the micromirrors 20, which in turn, controls their movement. Of course, the movement may be in other directions, such as sideways.

These micromirrors 20 may also be realized by piezomechanically-actuated integrated photonics, which bend waveguides out of plane. Such an implementation can also make use of high Q/V waveguide-integrated photonic crystal cavities, which have recently been shown to realize efficient, diffraction limited spatial light modulation, as discussed in C. Panuski et al., “A full degree-of-freedom spatiotemporal light modulator”, Nature Photonics 16, 834-842 (2022).

### Switched Capacitor Implementation for Optical Memory

The implementations described so far make use of integrating charge directly onto the intrinsic capacitance of the modulator device. However, integration onto a separate capacitor connected in parallel to the photodiode and the modulator may also be possible.

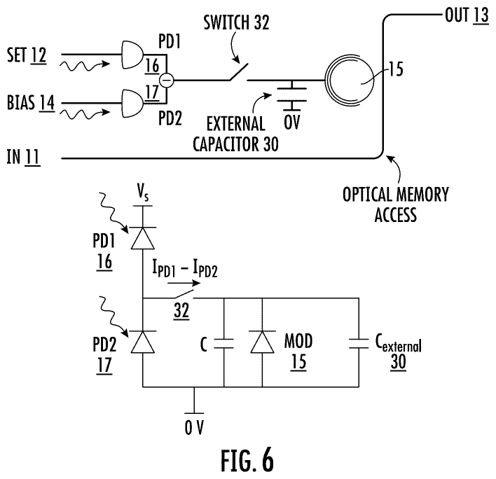

FIG. 6 shows an example implementation. Here, charge is injected onto a separate external capacitor 30 connected in parallel to the modulator 15, which is realized for instance using a metal-insulator-metal (MIM) structure on chip. The photodiode 16 associated with the “SET” port 12 is connected to the external capacitor 30 through a switch 32 that can be turned on and off. The switch 32 may be, for example, a FET device. When the switch 32 is closed, charge can be injected into the external capacitor, producing a voltage across the modulator. This may be referred to as the memory writing state. Once integration is complete, the switch 32 can be opened to eliminate leakage and store the charge in memory. This may be referred as the memory storage state. An optical signal, coupled into the “IN” port 11 and read out from the “OUT” port 13, is used to read the state of the memory. Here, the “BIAS” port 14 and its associated photodiode 17 act as a reset to discharge the memory. The “BIAS” port is also used to rewrite the optical memory to a “O”. The bottom of FIG. 6 shows an electrical circuit representation of this device when implemented with a pn-doped modulator in silicon photonics and shows the modulator 15 modelled as a diode and the parasitic capacitor in parallel. Additionally, the external capacitor 30 is shown in parallel with the modulator 15. The switch 32 is in series with these elements. Alternatively, this “BIAS” port 14 can be eliminated if fast, on-demand discharge of the memory is not required. For example, the RC-lifetime of the memory is dependent on the integrating capacitance C and the shunt resistance of the modulator R. For sufficiently large shunt resistances, the intrinsic capacitance of the modulator may be adequate, such that the external capacitor 30 may be eliminated.

If the memory capacitor is connected to a modulator 15 with negligible leakage current, such as a MEMS device (which have ˜fA of DC leakage), then this memory may be optically accessed. The memory is programmed by inputting light to the photodiode 16 and read out by sending light through the modulator 15. Potential applications of such a technology include photonic accelerators for deep neural networks, where model parameters can be optically stored and retrieved, and photonic engines for quantum information processing, where gate sequences can be optically accessed.

### Alternative Implementations of Reset Functionality

The implementations discussed thus far use a balanced photoreceiver to reset the integrated charge on the modulator. The optical power input into the “BIAS” port 14 on FIG. 2 produces a constant rate of discharging for the modulator capacitance, ensuring fast response speeds (otherwise, the reset time of the gate will be the RC time, which will be long as the shunt resistance typically exceeds 1 gigaohm).

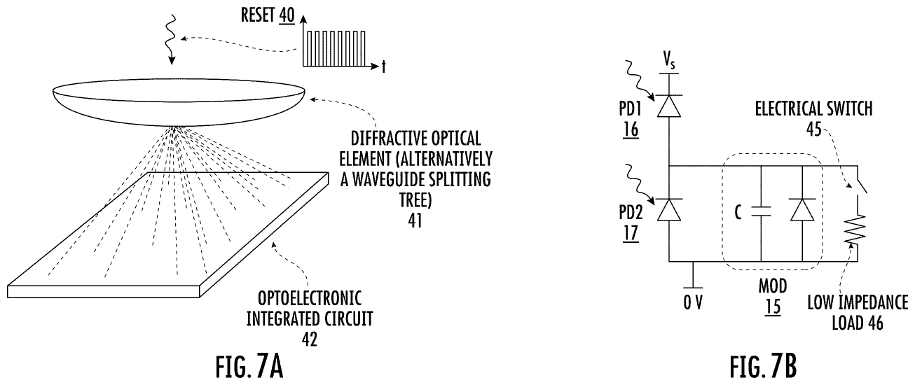

FIGS. 7A-7B show two alternative implementations that do not require constant input power into the reset port. In FIG. 7A, instead of a constant, CW optical input, a reset pulse 40 is sent to the gate periodically on a clock cycle. This reset pulse 40 is generated by a single electro-optical modulator and is simultaneously fanned out to all logic gates on a chip 42. As the reset signal is optical, fanout can passively and trivially be implemented-either through a single diffractive optical element 41 above the chip 42 or a waveguide splitting tree on chip 42.

FIG. 7B shows an electrical implementation of the reset functionality. Here, the modulator 15 is connected through an electrical switch 45 to a low electrical impedance 46. Reset is achieved by actuating the electrical switch 45 and connecting the modulator 15 to the low electrical impedance 46. The reset time, which is RC-limited, becomes extremely short as the load impedance is small.

### Applications

### Optical Neural Networks

Recently demonstrated optical neural network hardware has shown efficient matrix multiplication with less than 1 photon/multiply-accumulate operation (MAC). This is achieved by integrating the results of photoelectric multiplications onto a capacitor over many time steps and reading out only when the entire vector-vector product is complete. However, the latency of these systems is significantly higher than single-shot architectures, as they are limited by the need to amplify and digitize the output product into the electrical domain, apply the nonlinear activation function, and then re-encode onto an optical carrier for the subsequent layer in the deep neural network.

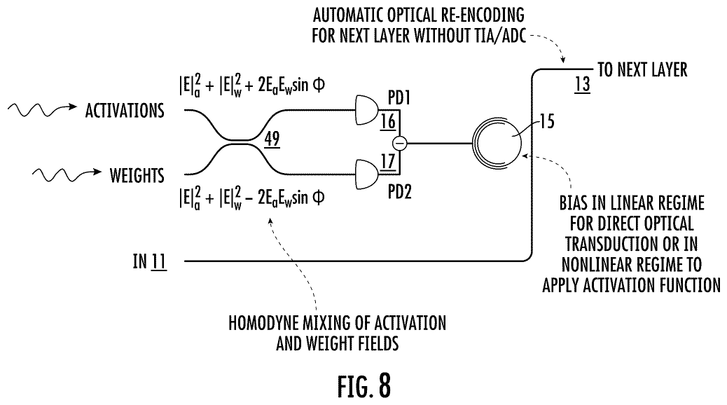

The described photoelectric gate can be used to directly transduce the integrated photocurrent back onto an optical carrier by receiverless driving of a modulator. An example implementation is shown in FIG. 8. Here, the difference current of the photodiodes 16, 17, which computes the photoelectric product, is directly integrated onto the intrinsic capacitance of the modulator 15. Light input into the modulator 15 therefore automatically transduces the result of the computation back into the optical domain.

Depending on the biasing of the modulator 15, different functions can be realized for the integrated signal. Biasing the modulator 15 in a linear regime enables automatic transduction of the integrated signal onto the optical domain. Alternatively, biasing the modulator 15 in a nonlinear regime enables direct implementation of the nonlinear activation function.

FIG. 8 shows the inputting of optical fields generated by the homodyne mixing of “activation” and “weight” signals into the “SET” port 12 and “BIAS” port 14 of the photoelectric gate. These signals are created by interfering the activation and weight signals on a 50-50 beamsplitter 49, which for instance could be implemented by a directional coupler or multi-mode interferometer on integrated photonics. This serves to implement photoelectric multiplication for optical neural networks. Similar techniques are shown in R. Hamerly et al., “Large-Scale Optical Neural Networks Based on Photoelectric Multiplication”, Physical Review X 9, 021032 (2019) and U.S. Patent 11, 373,089, which are incorporated by reference. The integrated photocurrent, which corresponds to the dot product of the two input signals in time, can be used to detune an optical modulator 15, enabling direct optical transduction of the vector-vector dot product at the output 13 without amplification (TIA) or digitization (ADC). Biasing the modulator 15 in linear or nonlinear regimes implements direct optical readout of the dot product or incorporation of a nonlinear activation function.

### Wavelength Conversion for Optical Packet Switching

Optical packet switching is a critical requirement for next-generation, low-latency optical networks. Oftentimes, these packets need to be switched from one wavelength channel to another, depending on the current occupancy of a given fiber. This is a cumbersome process, as it requires detecting the signal, digitizing and then re-encoding on a new optical carrier. Alternatively, all-optical frequency conversion, for instance making use of second-or third-order material nonlinearities, require extremely high optical pump powers and can moreover pollute the signal band with unwanted Raman noise.

The photoelectric logic gate described herein can function as an ultra-efficient wavelength converter. Here, input data is detected on the photodiode, which directly drives the modulator and re-encodes the signal onto the light passing through the modulator. The “control” signal, input into the “SET” port in FIG. 2, and the “modulator” signal, input into the “IN” port of FIG. 2, can be in completely different wavelength bands; moreover, as modulators and photodiodes operating at 10s of GHz are readily available in photonics foundries, this device can directly convert wavelength channels at Gb/s datarates.

### Comparators for Optical Nonlinear Signal Processing

The bistability of the photoelectric logic gate described herein can be exploited to produce an optical comparator, as shown in FIG. 3. A comparator is a device that takes two inputs and rails to one of two logic levels depending on which input is larger. Here, the two signals that are compared are input into the “SET” port 12 and the “BIAS” port 14 of the device. If the top input is stronger than the bottom input, net current will flow into the modulator capacitance and the device will rail to the supply forward of voltage (plus the voltage the photodiode). Alternatively, if the bottom input is stronger, net current flows out of the device, depleting the charge and railing the device to ground (minus the forward voltage of the photodiode).

### Optical Digital-to-Analog Conversion

Digital-to-analog converters (DACs) interface between a set of digital symbol inputs X₀, X₁, . . . , X_{N-1} and an analog multilevel output ΣXᵢ2⁻¹. Realizing high speed (>10 GSa/s), energy-efficient, and accurate DACs in electronics for ultra-fast signal processing has remained an outstanding challenge. Optical digital-to-analog converters could realize substantial benefits in speed and energy efficiency over their electronic counterparts.

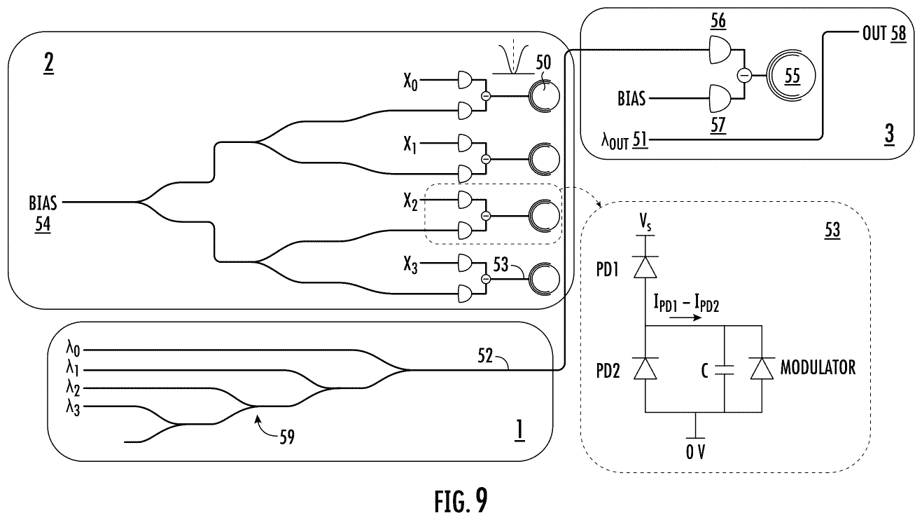

The photoelectric logic gate described herein can be used to realize optical digital-to-analog conversion. An example implementation of a 4-bit DAC is shown in FIG. 9. The optical digital-to-analog conversion takes place in three stages:
1. In the first stage, pump wavelengths λ₀, λ₁, . . . , λ_{N-1} are incoherently combined into a single bus waveguide 52 through a binary tree of 2−1 splitters 59. Each pump wavelength i is cascaded through i+1 splitters, such that each pump wavelength i is weighted in intensity by a factor of ½ relative to the preceding wavelength i.
2. In the second stage, the bus waveguide 52 is modulated by N photoelectric gates 53 in series, each of which are resonance locked to one of the N input pump wavelengths. Each modulator 50 applies an “on-off” keying signal that either fully transmits or extinguishes the optical signal. Here, the “BIAS” port 54 is used to set the threshold between an optical “1” and an optical “0.” An electrical circuit representation of each photoelectric gate 53 is shown at the lower right of the figure.
3. The final stage incoherently sums the optically weighted signals λ₀, λ₁, . . . , λ_{N-1} with a single photodiode 56. This photodiode drives a final modulator 55 off-resonance to produce the analog optical output 58. A bias may be applied to the “BIAS” photodiode 57. The wavelength of the input signal 51 that the final modulator 55 acts on can be any of the input wavelengths or a different wavelength altogether, which enables it to act as both a digital-to-analog converter and a frequency/wavelength converter simultaneously.

An additional benefit of this architecture is that as the transduction is mediated electro-optically, the output wavelength does not need to be the same as any of the input or bias wavelengths. Thus, the optical DAC can also function as an energy-efficient wavelength converter.

A key challenge for prior implementations of optical DACs has been the compounding effects of analog errors. This architecture is constructed to realize high-precision conversions, despite being performed in the analog domain:
1. While FIG. 9 depicts the pump wavelengths being combined with a binary tree of 2×1 splitters 59, they can also be combined with a programmable tree of Mach-Zehnder interferometers. Such an architecture, in tandem with hardware error correction algorithms for photonics, enables precise weighting of input signals regardless of component errors or transmission losses.
2. This architecture is not sensitive to minor variations in optical power between the different input signals. The nonlinearity integrates charge; thus, slight variations in optical power will still result in the modulator capacitance being charged to the same voltage, which is set by the supply rail.
3. The final, multi-level analog output is encoded onto a new optical carrier. Thus, the transmission loss of this architecture does not increase with the bit precision (i.e. the number of ring modulators required).

### Optical Logic Gates

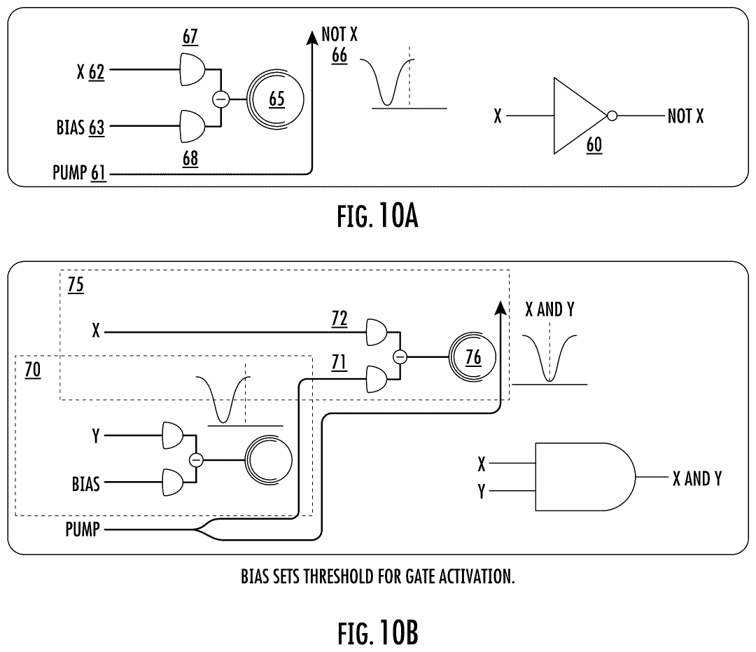

The photoelectric gate can be used to realize logic gates on optical fields. FIG. 10A shows the implementation of a NOT gate, also referred to as an inverter 60. As described above, a photodiode 67 is associated with the “SET” port and another photodiode 68 is associated with the “BIAS” port. The modulator 65 is optically biased such that when it charges up to the top rail, the input light (or PUMP 61) is extinguished. When the incident signal X 62 (on the “SET” port) is greater than the BIAS signal 63 (on the “BIAS” port), the modulator 65 tunes into resonance and the optical output 66 is extinguished by the modulator 65, producing a logical inversion. On the other hand, if the incident signal X 62 is less than BIAS signal 63, the modulator 65 does not charge up; the modulator 65 has full optical transmission and a strong optical signal exits the gate as optical output 66. Alternatively, the gate can be operated in a configuration where the incident signal X 62 and BIAS signals 63 are reversed. Thus, the incident signal X 62 is used as a reset and the BIAS signal 63 is used as a set port. Here, the modulator 65 should be biased to resonance; in this case, when the incidence signal X 62 is less than BIAS signal 63, the modulator 65 is charged up and a strong optical signal exits the gate as optical output 66. When incident signal X 62 is stronger than BIAS signal 63, net charge is depleted and the modulator 65 remains on resonance, extinguishing the optical output 66.

FIG. 10B shows the implementation of an AND gate. Here, the input signal Y is first inverted using a NOT gate 70, which can be implemented with either of the configurations described in the previous paragraph and includes two photodiodes and a modulator. The output of this NOT gate 70 is used as the “BIAS” 71 for a second gate 75, the X variable is used as the “SET” 72 for the second gate 75. However, unlike the NOT gate 70, the modulator 76 in the second gate 75 is biased to resonance such that an optical input of “0” produces an optical output of “0”, i.e. a buffer. This produces the following logical truth table:

| X | Y | NOT Y | AND GATE output |
|---|---|---|---|
| 0 | 0 | 1 | 0 |
| 0 | 1 | 0 | 0 |
| 1 | 0 | 1 | 0 |
| 1 | 1 | 0 | 1 |

Whenever X is 0, the AND gate will always produce 0 as charge is depleted from the modulator 76 and the modulator 76 remains biased in resonance. If Y is 0, the first NOT gate 70 inverts it to a strong optical signal “1.” This signal prevents integration of charge onto the modulator 76 in the second gate 75; as a result, no matter whether X is 0 or 1, the modulator 76 does not detune and the output signal is extinguished. Only when X is 1 and Y is 1 (and therefore inverted, such that there is no bias signal 71 to the second gate 75) is there full optical transmission out of the modulator 76 in the second gate 75. Note that the BIAS input on the first NOT gate 70 sets the threshold for gate activation. Further, in some embodiments, the PUMP signal for each gate may be more than 4 times larger than the BIAS input to guarantee fanout/cascadability.

These two gates can be cascaded to implement a NAND gate, which is universal; thus, the photoelectric logic gate can realize universal logic in the optical domain. Specifically, the output from the AND gate shown in FIG. 10B may serve as the input to a second NOT gate (similar to that shown in FIG. 10A) to produce the NAND gate. In this scenario, the output from the AND gate serves as the input to the SET port of the NOT gate that is in communication with a photodiode. A pump signal may be used as the “IN” signal for the second NOT gate.

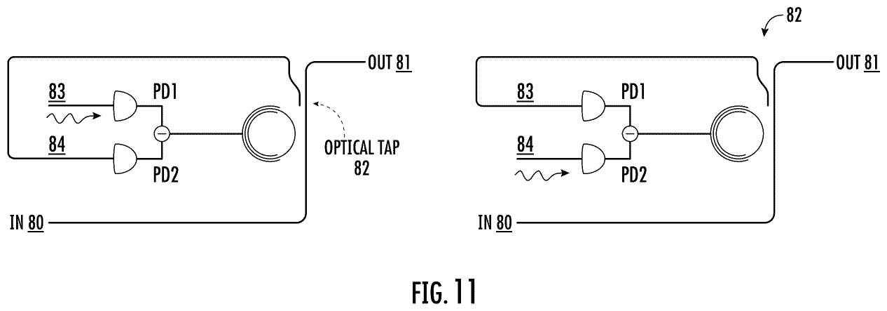

The nonlinearity of the logic gate can be further enhanced by employing internal feedback, as depicted in FIG. 11. Here, part of the output signal 81 (generated from the input signal 80) is tapped off using an optical tap 82 and fed back into one of the two input ports 83, 84, functioning as the optical analogue of an electronic operational amplifier (op-amp). Depending on which port the output signal 81 is tapped off into and the biasing of the modulator 85, the gate can implement either a buffer or inverter functionality, as seen in the two different configurations.

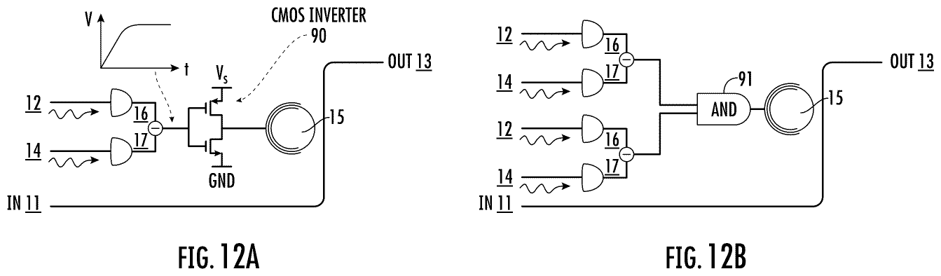

As the photoelectric logic gate integrates optical power up to a supply rail, it is also perfectly suited for directly interfacing to digital logic gates. Prior implementations of optical nonlinearities are not well suited to digital circuitry, as their output is dependent on instantaneous optical power and thus it is challenging to guarantee the device voltage reaches the required logic levels. Here, as the logic gate always charges up to the supply rail (emulating a digital electronic gate), it can directly interface to digital circuitry or individual transistors. As an example, instead of realizing an AND gate optically as shown in FIG. 10B, an AND gate can be realized in digital logic before transducing back to the optical domain, as shown in FIGS. 12A-12B. FIG. 12A shows a CMOS inverter 90 directly driven with the integrated voltage, while FIG. 12B shows an AND gate 91 implemented in electronics before being transduced back onto the optical domain. In both embodiments, the current from the photodiodes is integrated in the input capacitance of the digital logic gate, causing the voltage at the input to the digital logic gate to assume a value that is roughly equal to the supply rail or ground. Note that while an AND gate 91 is shown, other logic functions, such as NAND, OR and NOR may also be employed.

### Single-Photon and Photon Number Resolving Detection

An outstanding challenge for large-scale, integrated quantum photonic circuits is detection. While conventional photodiodes are straightforward to implement in integrated photonics, single photon detection typically requires superconducting materials that operate at cryogenic temperatures.

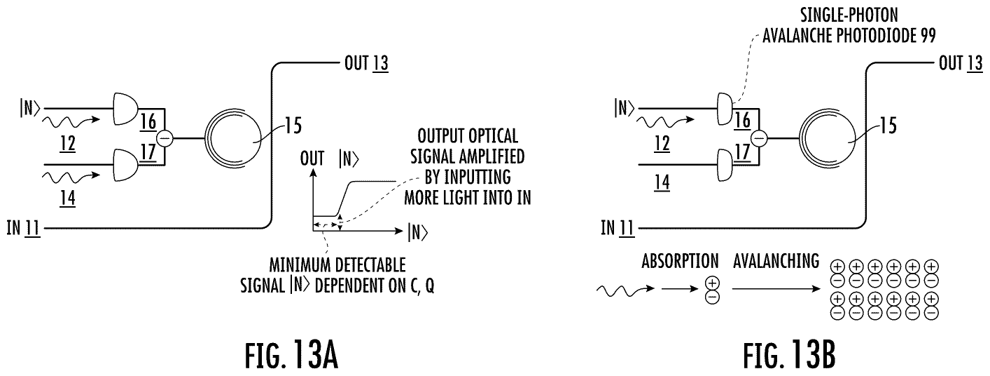

Depending on the biasing of the modulator, the photoelectric logic gate implements gain. For instance, suppose the modulator is biased to extinction. As the output transmission at this point nonlinearly increases with voltage, a fixed number of input photons will produce an output swing in optical power that is far larger (see FIG. 13A-13B). Moreover, the optical power output from the device is independent of the input field and can be arbitrarily large, simply by increasing the optical power at the “IN” port. Thus, standard electronics and photodetection can be used to readout the signal.

In FIG. 13A, the nonlinear response of the modulator 15 produces effective gain. For a low enough capacitance C and high enough quality factor Q, the minimum detectable signal may be as small as a single photon. Moreover, the output optical signal 13 can be arbitrarily amplified by inputting more light into the input port IN 11.

This behavior can be used to implement photon detection at very low photon counts-the lower the device capacitance and the higher the cavity finesse, the lower the threshold optical power needed. Earlier, about 60,000 photons are estimated to be needed for a 1 V swing on the modulator, assuming a capacitance of tens of femtofarads and a quality factor of roughly 5,000. Far higher quality factors have previously been realized in integrated photonics, as well as capacitances on the order of single fF; a sufficiently low capacitance in tandem with a high-finesse cavity (such as a photonic crystal) may enable single and few-photon detection. Moreover, as the device integrates optical power, different changes in optical response will correlate to different input optical powers. Thus, this device could also be used to implement photon number resolving detectors.

Alternatively, instead of a conventional photodiode, a single-photon avalanche photodiode (SPAD) 99 can be connected to the modulator 15, as shown in FIG. 13B. In a SPAD, which is strongly reverse-biased, the absorption of a single photon produces many electron-hole pairs through avalanche multiplication and can therefore drive an optical modulator.

### Optical Amplification

As discussed in the previous section, small amounts of incident optical power can induce large changes in output transmission; moreover, the output optical power can be arbitrarily high simply by increasing the power input to the “IN” port 11. This device can therefore be used to optically amplify and regenerate signals on chip with an energy consumption that is orders of magnitude lower than conventional erbium-doped fiber amplifiers (EDFAs) or semiconductor optical amplifiers (SOAs).

Moreover, this device can implement phase-sensitive gain simply by placing a 50-50 beamsplitter 49 before the two inputs, as shown in FIG. 8. In this case, a strong local oscillator would be input into one port and the signal to be amplified would be input into the other.

Phase sensitive amplifiers are also useful for emerging applications in computing, such as photonic Ising solvers. These systems, which require phase-sensitive gain to implement the Ising Hamiltonian, can be used to accelerate combinatorial optimization and certain classes of NP-hard problems.

The present system has many advantages. By utilizing accumulated charge, as opposed to instantaneous charge, it is not susceptible to power fluctuations. This enables cascadability and allows the architecture to have immediate applications for emerging photonic accelerators for deep neural networks, as well as other systems that require inline processing of data in the optical domain. Additionally, this architecture can realize modulation with bandwidths exceeding 20 GHz, limited by the photodiode/modulator bandwidth, and does not require external amplifiers. As a result, this architecture can realize energy consumptions on the order of ˜1 fJ/OP. Additionally, this architecture can implement a NAND gate in the optical domain, which is sufficient to implement universal logic entirely in the optical domain.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A photoelectric gate, comprising:
a first port in communication with a first photodiode to receive a control signal; and
an optical modulator to modulate an input signal to form an output signal;
wherein photogenerated current from the first photodiode is integrated onto an intrinsic capacitance of the optical modulator to control a state of the optical modulator.

2. The photoelectric gate of claim 1, wherein the control signal and the input signal are different wavelengths to allow the photoelectric gate to serve as a wavelength converter.

3. The photoelectric gate of claim 1, wherein the first photodiode comprises a single photon avalanche diode (SPAD) such that a single photon incident on the first photodiode is detected at the output signal.

4. The photoelectric gate of claim 1, wherein the intrinsic capacitance and a quality factor of the optical modulator are selected such that a single photon incident on the first photodiode is detected at the output signal.

5. The photoelectric gate of claim 1, wherein the optical modulator is a Mach-Zehnder modulator, tunable directional coupler, microring, microdisk, pn-doped silicon modulator or photonic crystal modulator.

6. The photoelectric gate of claim 1, further comprising a second port in communication with a second photodiode to receive a bias or reset signal, wherein photogenerated current from the second photodiode is subtracted from the photogenerated current from the first photodiode prior to being integrated onto the intrinsic capacitance of the optical modulator.

7. The photoelectric gate of claim 6, wherein the photoelectric gate serves as a comparator that compares the control signal to the bias or reset signal and wherein the output signal indicates a result on the comparison.

8. An optical inverter comprising the photoelectric gate of claim 6.

9. The optical inverter of claim 8, wherein the optical modulator is optically biased such that when it charges up to a maximum voltage, the input signal is extinguished such that the output signal is not present.

10. The optical inverter of claim 8, wherein the bias or reset signal is set to a fixed bias optical power.

11. An optical AND gate, comprising:
the optical inverter of claim 8; and
a second optoelectronic a gate, wherein the second optoelectronic gate comprises:
a second optical modulator to modulate a second input signal to form a second output signal;
a third port in communication with a third photodiode to receive a second control signal;
a fourth port in communication with a fourth photodiode to receive the output signal from the optical inverter, wherein photogenerated current from the fourth photodiode is subtracted from the photogenerated current from the third photodiode and then integrated onto an intrinsic capacitance of the second optical modulator to control a state of the second optical modulator;
wherein the input signal to the optical inverter and the second optoelectronic gate is a pump; and
wherein inputs to the first port of the optical inverter and the third port of the second optoelectronic gate comprise the inputs to the optical AND gate; and the output signal from the second optoelectronic gate comprises an output of the optical AND gate.

12. An optical NAND gate, comprising the optical AND gate of claim 11, wherein an output of the second optoelectronic gate serves as an input to a second optical inverter.

13. An optical memory, comprising:
the photoelectric gate of claim 6; and
a switch disposed between the photodiodes and the optical modulator, to isolate the optical modulator from the photodiodes in a memory storage mode and enable passage of current in a memory writing mode.

14. The optical memory of claim 13, further comprising a capacitor in parallel with the intrinsic capacitance of the optical modulator to retain the state of the optical modulator.

15. An optical neural network, comprising:
the photoelectric gate of claim 6;
wherein the first port in communication receives one of two signals obtained by homodyne mixing of an activation and weight signal; and
the second port receives a second of the two signals obtained by the homodyne mixing of the activation and weight signal.

16. The optical neural network of claim 15, wherein the optical modulator is operated in a linear regime.

17. The optical neural network of claim 15, wherein the optical modulator is operated in a non-linear regime to apply an activation function to the input signal.

18. A photoelectric gate, comprising:
the photoelectric gate of claim 6; and
an optical tap in communication with the output signal, where part of the output signal is fed back to the first port or the second port.

19. The photoelectric gate of claim 18, wherein the first port is in communication with a control signal and the part of the output signal is fed back to the second port.

20. The photoelectric gate of claim 18, wherein the second port is in communication with a control signal and the part of the output signal is fed back to the first port.

21. An optical Digital to Analog converter (DAC), comprising:
a first stage, comprising:
a plurality of photoelectric gates, wherein each photoelectric gate comprises:
a first port in communication with a first photodiode to receive a control signal, indicative of a digital value;
a second port in communication with a second photodiode to receive a bias signal; and
an optical modulator to modulate an input signal to form an output signal; wherein photogenerated current from the second photodiode is subtracted from the photogenerated current from the first photodiode prior to being integrated onto an intrinsic capacitance of the optical modulator to control a state of the optical modulator, wherein the optical modulator affects one wavelength;
wherein a plurality of pump wavelengths are incoherently combined into a single bus waveguide through a binary tree of 2×1 splitters and serve as the input signal to the first stage;
and a final stage, comprising:
a photoelectric gate comprising:
a first port in communication with a first final stage photodiode to receive the output signal from the first stage;
a second port in communication with a second final stage photodiode to receive the bias signal; and
a final stage optical modulator to modulate a second input signal to form a second output signal; wherein photogenerated current from the second final stage photodiode is subtracted from the photogenerated current from the first final stage photodiode prior to being integrated onto the intrinsic capacitance of the final stage optical modulator to control a state of the final stage optical modulator, and wherein the second output signal represents an analog representation of the digital values.

22. A photoelectric gate, comprising:
an optical modulator to modulate an input signal to form an output signal;
a digital logic gate having an input, and an output in communication with the optical modulator;
a first port in communication with a first photodiode to receive a control signal; and
a second port in communication with a second photodiode to receive a reset signal, wherein photogenerated current from the second photodiode is subtracted from the photogenerated current from the first photodiode prior to being integrated onto an input capacitance at the input of the digital logic gate disposed between the photodiodes and the optical modulator.

23. The photoelectric gate of claim 22, wherein the digital logic gate comprises an inverter.

24. The photoelectric gate of claim 22, wherein the digital logic gate comprises a second input, and further comprising:
a third port in communication with a third photodiode to receive a second control signal; and
a fourth port in communication with a fourth photodiode to receive a second reset signal, wherein photogenerated current from the fourth photodiode is subtracted from the photogenerated current from the third photodiode prior to being integrated onto an intrinsic capacitance at the second input of the digital logic gate.

25. The photoelectric gate of claim 24, wherein the digital logic gate comprises an AND gate, a NAND gate, an OR gate or a NOR gate.
